(19) United States
(12) Patent Application Publication
(10) Pub. No.: US 2016/0371448 A1
(43) Pub. Date: Dec. 22, 2016

(54) DISPLAYING PATIENT PHYSIOLOGICAL DATA

(71) Applicant: DRAEGER MEDICAL SYSTEMS, INC., Andover, MA (US)

(72) Inventors: Juan Pablo ESLAVA, Boylston, MA (US); Timothy Joseph COONAHAN, Sterling, MA (US)

(73) Assignee: Draeger Medical Systems, Inc., Andover, MA (US)

(21) Appl. No.: 14/896,658

(22) PCT Filed: Dec. 12, 2014
(86) PCT No.: PCT/US2014/070157

§ 371 Date: Dec. 7, 2015

(51) Int. Cl. G06F 19/00; G06F 3/0482

(52) U.S. Cl. CPC G06F 19/3406; G06F 3/0482

(57) ABSTRACT

A data-feed comprising patient physiological parameter values is received. A plurality of graphical objects is displayed in a substantially circular arrangement. At least one of the plurality of graphical objects is associated with a patient physiological parameter and has a size corresponding to a present patient physiological parameter value. The size for the at least one of the plurality of graphical objects is adjusted dynamically in response to changes in values of the corresponding patient physiological parameter values. Related apparatus, systems, techniques, and articles are also described.

### TECHNICAL FIELD

The subject matter described herein relates to displaying patient physiological data such as in a graphical user interface on a remote device.

### BACKGROUND

Routine monitoring of patient's physiological parameters, including vital parameters, is standard practice in healthcare settings, such as coronary and intensive care units, emergency rooms, ambulatory monitoring settings, operating rooms, and the like. Displays for visualizing patient parameters can have limited display space. Some methods of displaying patient physiological parameters can obscure diagnostic information needed to support the therapeutic decisions made for patients by healthcare providers and may not provide medical staff with continuous information regarding changes in a general condition of a patient. Additionally, the medical care workforce is increasingly becoming decentralized.

### SUMMARY

In an aspect, a data-feed comprising patient physiological parameter values is received. A plurality of graphical objects is displayed in a substantially circular arrangement. At least one of the plurality of graphical objects is associated with a patient physiological parameter and has a size corresponding to a present patient physiological parameter value. The size for the at least one of the plurality of graphical objects is adjusted dynamically in response to changes in values of the corresponding patient physiological parameter values.

In another aspect, a data-feed comprising patient physiological parameter values is received. A plurality of graphical objects is displayed arranged around a status object. At least one of the plurality of graphical objects is associated with a patient physiological parameter and has a size corresponding to a present patient physiological parameter value. The size for the at least one of the plurality of graphical objects is adjusted dynamically in response to changes in values of the corresponding patient physiological parameter values.

One or more of the following features can be included in any feasible combination. For example, the data-feed can be received from at least one patient medical device and the at least one data processor can be remote from the at least one patient medical device. The patient physiological parameter values of the data-feed can be dynamically changing based on one or more physical conditions of a patient. An alarm object can be displayed in a graphical user interface when an alarm condition is present in the data-feed. A status of a medical device generating the data-feed can be displayed in a graphical user interface.

The plurality of graphical objects can be displayed in a graphical user interface residing on a display space of a wearable computing device. The display space can be for augmenting reality of a wearer of the wearable computing device. The patient physiological parameter values can reflect a present value of a physiological state of a patient. An input characterizing a selection of one of the plurality of graphical objects can be received. A detailed graphical object comprising historical patient physiological parameter values can be displayed. The at least one of the plurality of graphical objects can be oval and the size can be a length of a first symmetrical axis of the oval. The size can be relative to a known normal value.

The status object can display a characterization of at least one of the patient physiological parameter values. The status object can characterize at least one of the patient physiological parameter values with a warning when the patient physiological parameter values satisfy a warning condition. The status object can display a status of a medical device.

Computer program products are also described that comprise non-transitory computer readable media storing instructions, which when executed by at least one data processor of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein provides many technical advantages. For example, patient physiological parameter values can be displayed in a manner that can enhance visualization of diagnostic information to support therapeutic decisions made for patients and monitoring thereof by healthcare providers. Physiological parameter data can be displayed in a manner that is sensitive to human perception allowing physicians to better identify abnormal changes in patient condition. Moreover, the current subject matter can enable a health care provider to act on identified abnormal changes in patient condition to better care for the patient. Furthermore, the current subject matter enables monitoring, interpretation, manipulation, and control of patient physiological parameter data.

In some implementations, the current subject matter can provide to a desk-less worker, such as a nurse or clinician, remote patient surveillance and command capabilities such that work routines associated with patient care, such as alarm management or patient monitoring of vital signals, can be performed from a remote location without disturbing the patient and/or the worker's routine thus providing for a more efficient work flow with improved care. Control of patient physiological parameter data can be enabled in a hands-free manner. Additionally, remote patient care can be delivered more quickly and efficiently. A mobile and decentralized workforce can be enabled through the use of mobile electronic devices that transmit and receive data.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram of an example process for displaying patient physiological parameter values;

FIG. 2 is a drawing illustrating an example interface in a display that can enable visualization of patient physiological parameter data;

FIG. 3 is a drawing illustrating the example interface of FIG. 2 in which a patient parameter value exceeds a known normal range;

FIG. 4 is a drawing illustrating the example interface of FIG. 2 in which a patient parameter value is below a known normal range;

FIG. 5 is a drawing illustrating the example interface of FIG. 2 in which a user has provided input to select the alarm object associated with temperature in order to initiate an action related to the patient's physiological parameter;

FIG. 6 is a drawing illustrating the example interface of FIG. 2 in which a user has provided input to select the graphical object associated with temperature in order to visualize additional physiological parameter data related to the selected graphical object;

FIG. 7 is a system block diagram of an example implementation of a system for monitoring a patient and displaying patient physiological parameter values in a manner that can enhance visualization of the physiological parameter data;

FIGS. 8A and 8B are drawings illustrating the example interface of FIG. 2 in which the status of a medical device generating a physiological parameter value feed is displayed on the central status object and graphical objects can appear and disappear if they are connected or disconnected; and

FIGS. 9A. and 9B illustrate implementations in which graphical objects change shape, size, and/or may include two or more sub-objects to display conditions of organs or body components with a multiple characteristic (e.g., lungs, hands, and the like).

Like reference symbols in the various drawings indicate like elements.

### DETAILED DESCRIPTION

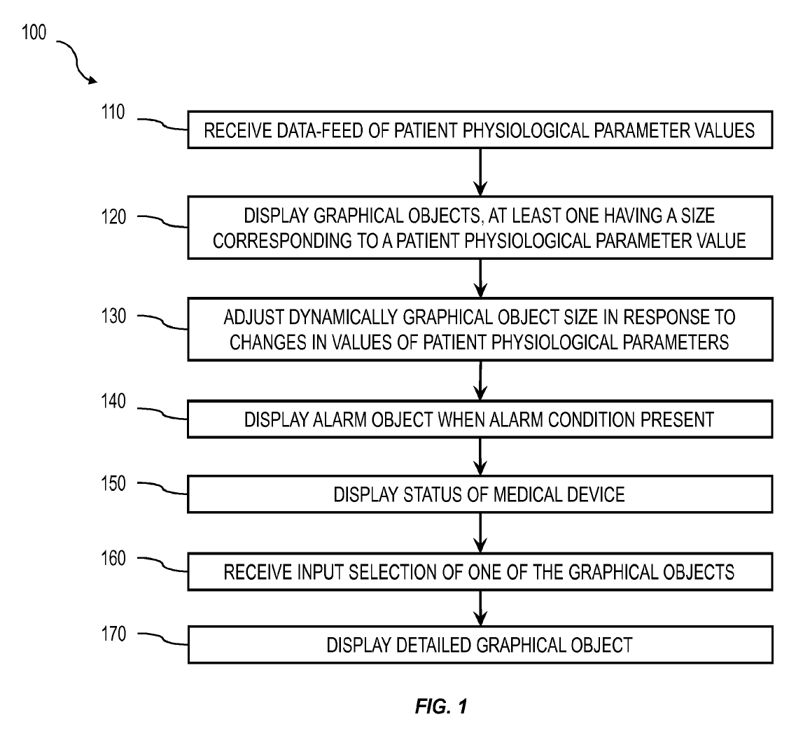

FIG. 1 is a process flow diagram of an example process 100 for displaying patient physiological parameter values in a manner that can enhance visualization of diagnostic information to support therapeutic decisions made for patients and monitoring thereof by healthcare providers. This visualization can include displaying graphical objects in a substantially circular arrangement and/or arranged around a status object. Additionally, the graphical objects can change in relative size according to qualitative patient physiological parameter conditions, such as a parameter value being outside predetermined acceptable values and/or ranges. Moreover, an interface including the graphical objects can provide for monitoring, interpretation, manipulation, and control of the patient physiological parameter data. Color can be used in combination with graphical object shape and arrangement in order to communicate information such as patient status, condition, and/or condition severity.

A data-feed can be received at 110. The data-feed can include patient physiological parameter values. The patient physiological parameters can reflect conditions of a patient and can include heart rate monitors, electrocardiograms (ECG), temperature, blood-oxygen levels (SPO2), blood pressure, respiratory rate, blood test results, and the like. In some implementations parameters can include patient parameters not typically monitored by devices but instead observed by staff, such as: mood, awareness, skin color, nail color, and eye color. The patient physiological parameters can be received from at least one patient medical device including sensors for acquiring the physiological parameters. The patient physiological parameters of the data-feed can be dynamically changing based on one or more physical conditions of a patient. For example, the data-feed can be in real-time or near-real time and can reflect a present value of a physiological state or condition of the patient, such as a present and dynamically changing heart rate.

A plurality of graphical objects can be displayed at 120. The graphical objects can be displayed in a substantially circular arrangement and can be associated with patient physiological parameters. In some implementations, graphical objects can be arranged around a central status object, and may or may not be in a substantially circular arrangement.

One or more graphical objects can be displayed with a size corresponding to a present patient physiological parameter value. For example, a graphical object associated with body temperature can be displayed as larger when body temperature is greater and can be displayed as smaller when the body temperature is lower. In an example implementation, graphical objects can take a symmetrical shape, such as a circular or oval shape, although other shapes are possible. Thus, shape and/or size of graphical objects can be indicative of severity of a patient condition.

Central status object can display a characterization of at least one of the physiological parameters. This characterization can include a warning or other signal when a physiological parameter satisfies a warning condition. For example, if a temperature of a patient rises beyond a known threshold, central status object can be displayed as a written warning (e.g., “high temp”). The central status object may also display other information, such as the status of a medical device as “ON” or “OFF.” The central status object may also display multiple conditions in a time sequence. For example, if there are two conditions to be displayed, condition 1 and condition 2, the central status object may first display condition 1 for a period, and then display condition 2 for a period. The sequence may repeat.

The size of at least one of graphical objects can be adjusted at 130 in response to changes in values of corresponding patient physiological parameter values. Adjusting may be dynamic and can correlate with changing of an associated patient physiological parameter value received on the data-feed at 110. For example, a graphical object associated with a patient's heart rate can change when patient's heart rate, received in data-feed at 110, changes. If heart rate increases, graphical object size can increase and if heart rate decreases, graphical object size can decrease.

In the example implementation in which graphical object is symmetrical, such as circular or oval, the size can be the length of a symmetrical axis of the object. In this implementation, the graphical object will change size along one of the symmetrical axis'. The size can be relative to a known normal value or range. For example, a graphical object associated with temperature can be displayed at a size relative to normal human body temperature (e.g., 98.7 degrees) such that a first symmetrical axis length is shown as the measured physiological parameter value and a second symmetrical axis length is fixed at the known normal value. In such a configuration and when graphical object is circular or oval and when temperature is normal (e.g., 98.7 degrees) graphical object is a circle (e.g., the first and second symmetrical axis are equal). When temperature is abnormal (e.g., greater than or less than 98.7 degrees), graphical object is oval.

Alarm object can be displayed at 140 when an alarm condition is present in data-feed. The alarm condition may either be determined from physiological parameters (e.g., by comparing the physiological parameter value to a known threshold) or an indicator informing of the presence of the alarm condition can be received, for example, in the data-feed. The alarm condition can be generated by and/or received from a medical device or a central monitoring station. The alarm object can take any number of shapes and can be displayed next to a corresponding graphical object that is associated with the patient physiological parameter that has triggered the alarm condition.

A status of a medical device generating a physiological parameter value feed can be displayed at 150. The status can include whether the medical device and/or sensor is powered on or off, whether sensors are disconnected, whether sensors are broken or otherwise not recording values, and whether the medical device and/or sensor is in standby mode. For example, graphical objects can appear and disappear if they are connected or disconnected respectively.

Displaying of graphical objects, center status object, alarm object, and/or medical device status can occur in a graphical user interface that can receive input from a user and allow a user to manipulate and control the data (and in some implementations control the medical device), for example, in response to changes in physiological parameter values. For example, at 160, input characterizing a selection of one of the graphical objects can be received. When a graphical object is selected, a number of actions can be possible. For example, upon selection on an object (e.g., graphical objects, control objects, alarm object, and/or menu object), additional objects can be displayed allowing the user to “drill-down” on physiological parameters to manipulate the data for better visualization of the data, and/or to control aspects of the patient's treatment.

For example, at 170, a detailed graphical object can be displayed that shows historical patient physiological parameter values. The detailed graphical object can take the form of a graph, such as a line plot showing the associated physiological parameter values over time. Other detailed graphical objects are possible. Such as histograms, instructions for care, task reminders, and other patient information. Selection of the alarm object (or in some implementations graphical object) can also cause display of control objects, selection of which can cause initiation of an action. The actions can include, for example, raising an alarm, delaying an alarm, disabling an alarm, and re-setting an alarm. The action can include providing for notes to be taken (e.g., a verbal recording and/or text can be input), and a call can be made, for example, to a nurse station or other location. The actions can include modifying a therapy treatment of the medical device.

Other objects may also be displayed. For example, a menu object and a patient's name, warnings, quality scores (such as number of minutes, hours, or days condition has existed), number of interventions, key performance indicators specific to parameter or condition, and the like, can be displayed. Display of other objects are possible

The current subject matter can be implemented with a display on a wearable computing device. In some implementations, the graphical objects can be displayed in a graphical user interface residing on a display space of the wearable computing device that is for augmenting reality of a wearer. The wearable computing device can include at least one data processor and display, such as a GOOGLE GLASS® or EPSON MOVERIO® device having a display that augments reality of a wearer. Inputs can be provided via verbal, gesture, and/or touch input. The current subject matter is not limited to wearable devices but can be included with any computing device and/or display including, for example, mobile devices such as smart phones and tablets, nurse workstations, and within medical devices having displays, such as patient monitors and anesthesia devices.

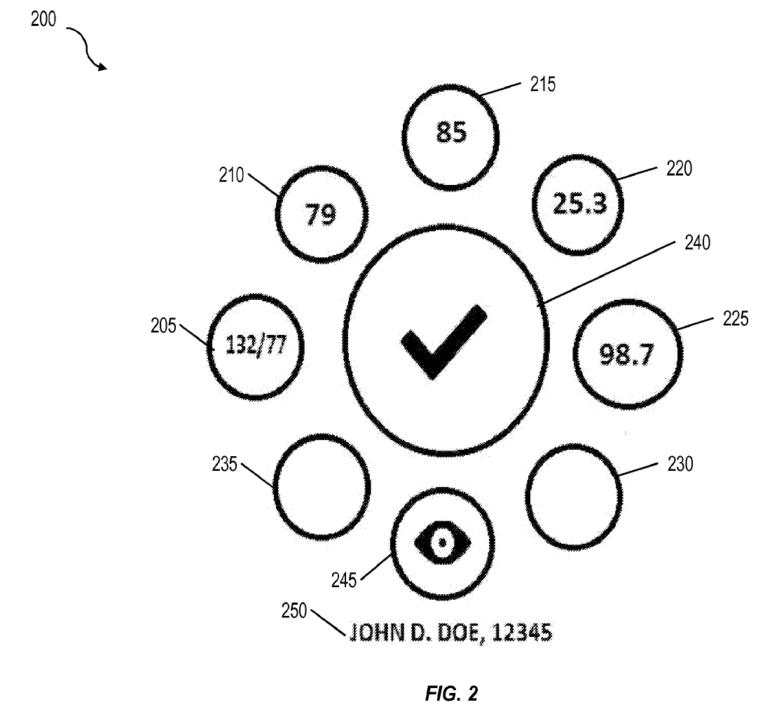

FIG. 2 is a drawing illustrating an example interface 200 in a display that can enable visualization of patient physiological parameter data. Graphical objects 205, 210, 215, 220, and 225 are displayed and are arranged in a substantially circular configuration. Each graphical object (205, 210, 215, 220, and 225) can be associated with a different physiological parameter, values of which are received by a data-feed. In the implementation of FIG. 2, graphical object 205 displays blood pressure, graphical object 210 displays heart rate, graphical object 215 displays blood oxygen (SPO2) level, graphical object 220 displays respiratory rate, and graphical object 225 displays body temperature. Additional graphical objects 230 and 235 are displayed and are unassociated with a physiological parameter, although additional physiological parameters could be displayed. Because each of the physiological parameter values are within a known normal range and/or value, each graphical object (205, 210, 215, 220, and 225) is displayed as a circle at the same relative size.

A status object 240 is centrally located and displayed as a check icon, indicating that all received physiological parameters are within known normal ranges or values. The graphical objects (205, 210, 215, 220, 225, 230, and 235) are arranged around the status object 240, which is central to the other objects. Additionally, a menu object 245 is illustrated, which, when selected, can allow for access to additional objects.

Patient information 250, such as name and identity number, can also be displayed.

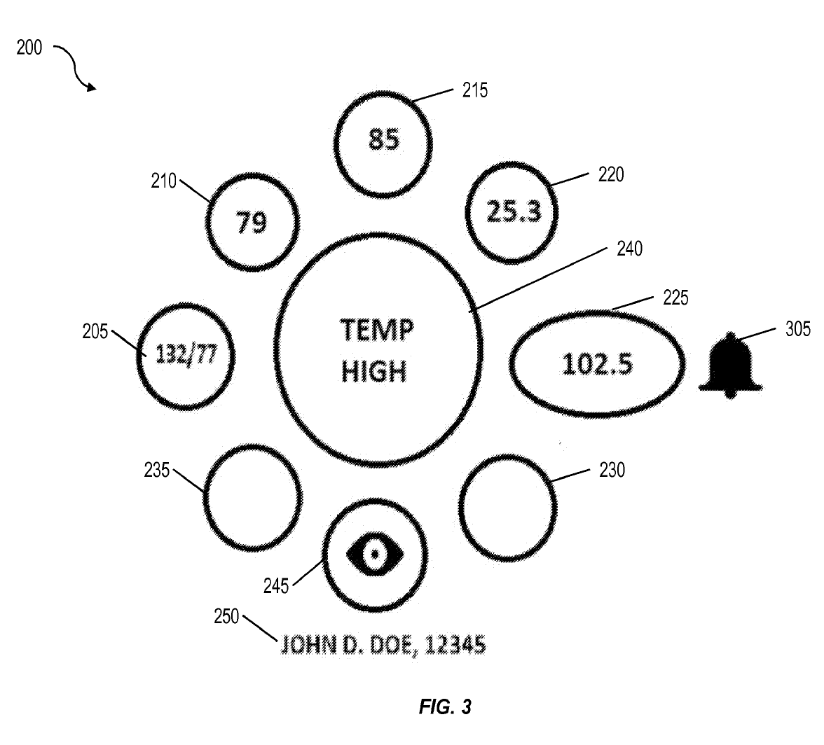

FIG. 3 is a drawing illustrating the example interface of FIG. 2 in which a patient parameter value exceeds a known normal range. Specifically, the patient's temperature has changed to an above-normal value. Graphical object 225 associated with temperature has changed size along a first symmetrical axis such that graphical object 225 is larger, indicating an above-normal temperature. In addition, status object 240 indicates that the temperature is high. An alarm object 305 is displayed adjacent the graphical object 225 associated with temperature. The alarm object 305 indicates that an alarm condition is met (e.g., temperature is above a known-normal value or another condition is satisfied) and can serve as a further indicator to the user that the patient's physiological parameter values may be abnormal.

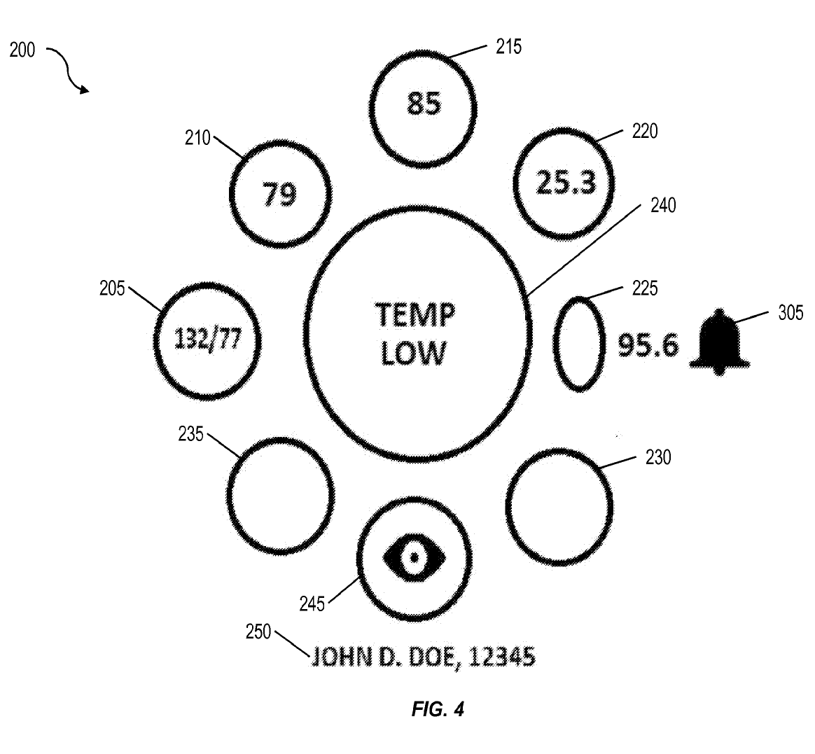

FIG. 4 is a drawing illustrating the example interface 200 of FIG. 2 in which a patient parameter value is below a known normal range. Specifically, the patient's temperature has changed to a below-normal value. Graphical object 225 associated with temperature has changed size along a first symmetrical axis such that graphical object 225 is smaller, indicating a below-normal temperature. In addition, status object 240 indicates that the temperature is low. Alarm object 305 adjacent graphical object 225 also indicates that an alarm condition is satisfied.

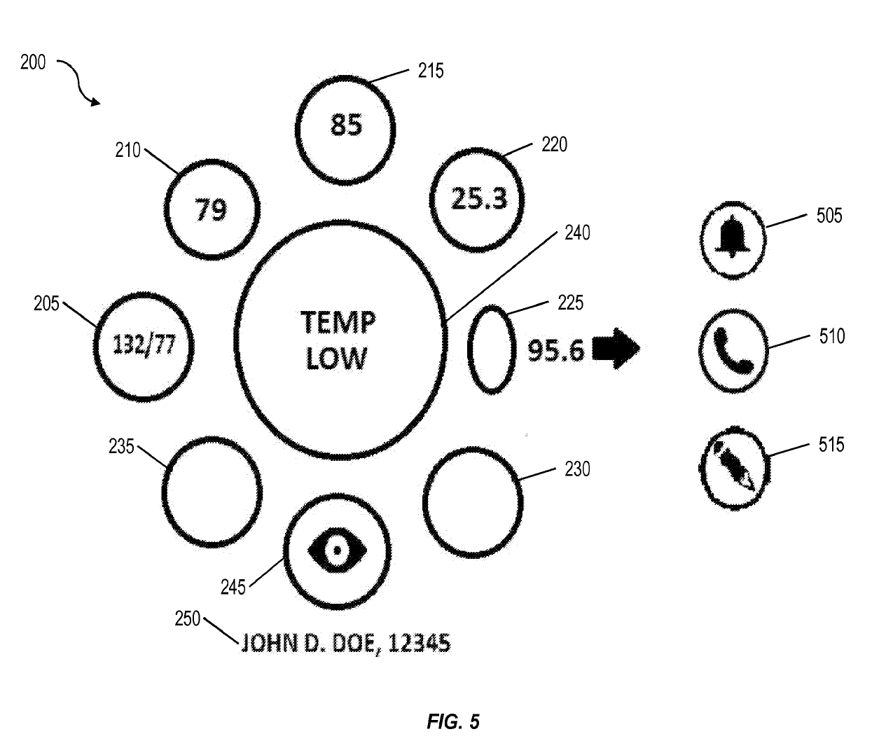

FIG. 5 is a drawing illustrating the example interface 200 of FIG. 2 in which a user has provided input to select the alarm object 305 associated with temperature in order to initiate an action related to the patient's physiological parameter. Upon selection of the alarm object 305 (or in some implementations the graphical object 225), additional control objects are displayed including alarm control object 505, phone control object 510, and note control object 515. Selection of the control objects can cause initiation of an action. For example, selection of alarm control object 505 can raise an alarm, delay an alarm, disable an alarm, and/or re-set an alarm. Selection of the phone control object 510 can cause initiation of a phone call (e.g., through a wearable device). The phone call can be made to a nurse station or other recipient. Selection of the note control object 515 can cause initiation of an interface for providing for notes to be taken (e.g., a verbal recording and/or text can be input and added to the patient's medical records) and/or the patient's medical records can be displayed.

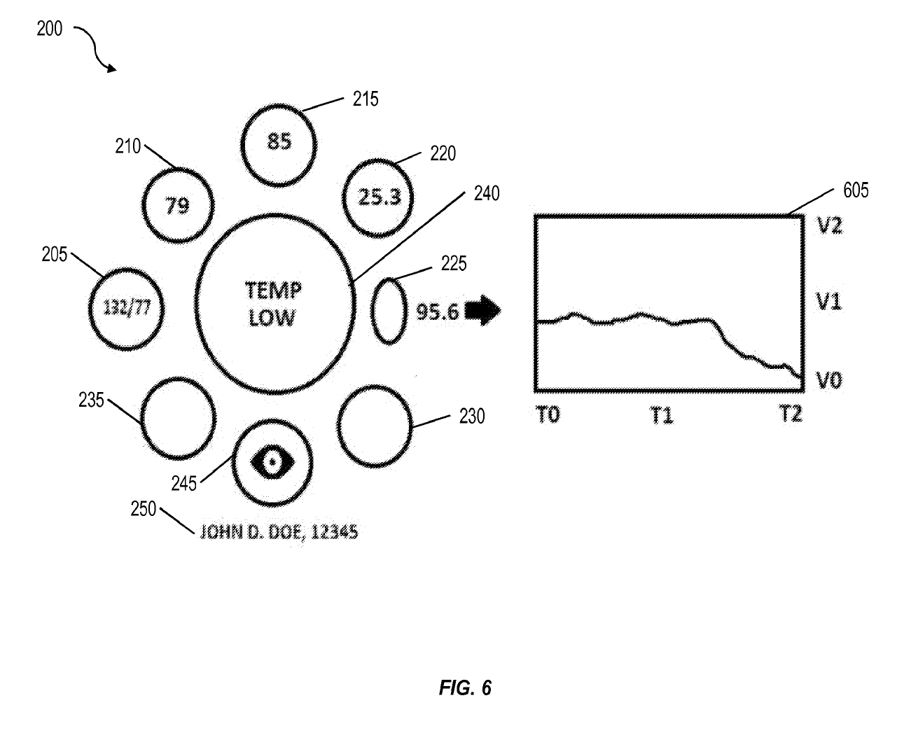

FIG. 6 is a drawing illustrating the example interface 200 of FIG. 2 in which a user has provided input to select the graphical object 225 associated with temperature in order to visualize additional physiological parameter data related to the selected graphical object. A detailed graphical object 605 is displayed which can include a graph of the patient's temperature over time. In the example of FIG. 6, the temperature is shown to have decreased over time.

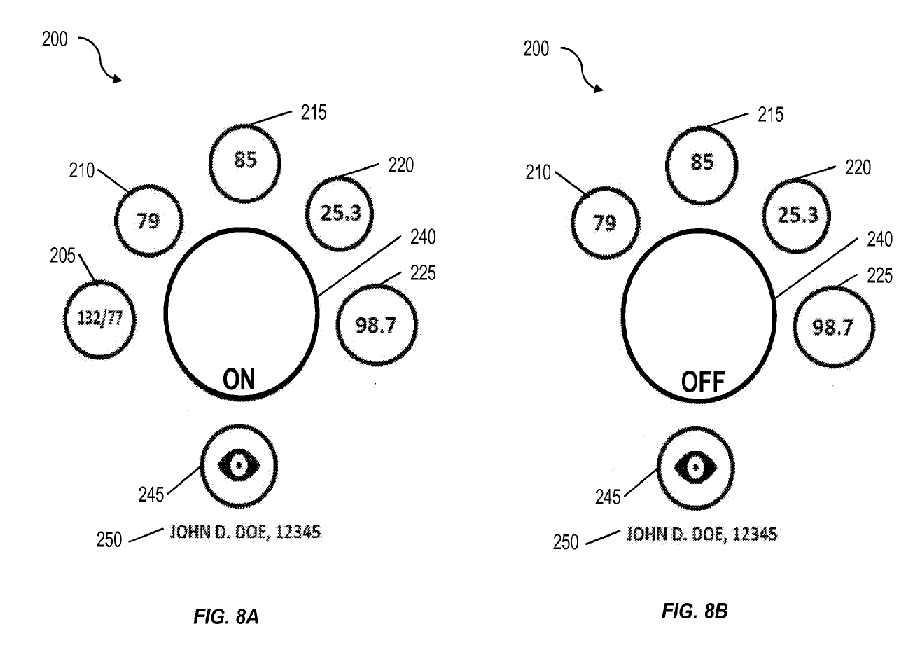

FIGS. 8A and 8B are drawings illustrating the example interface 200 of FIG. 2 in which the status of a medical device generating a physiological parameter value feed is displayed on the central status object 240 and graphical objects can appear and disappear if they are connected or disconnected respectively. The status can include whether the medical device and/or sensor is powered on or off, whether sensors are disconnected, whether sensors are broken or otherwise not recording values, and whether the medical device and/or sensor is in standby mode. In FIG. 8A, the central status object 240 indicates that the medical device is “ON” and each graphical object (205, 210, 215, 220, and 225) is associated with a different physiological parameter. Because the sensors associated with the displayed graphical objects (205, 210, 215, 220, and 225) arc connected, the respective graphical object is displayed. In FIG. 8B, the blood pressure sensor is disconnected (e.g., broken, disconnected, or not taking readings) and so the associated graphical object 205 is not displayed. Additionally, the central status object 240 shows the status of the medical device as “OFF.”

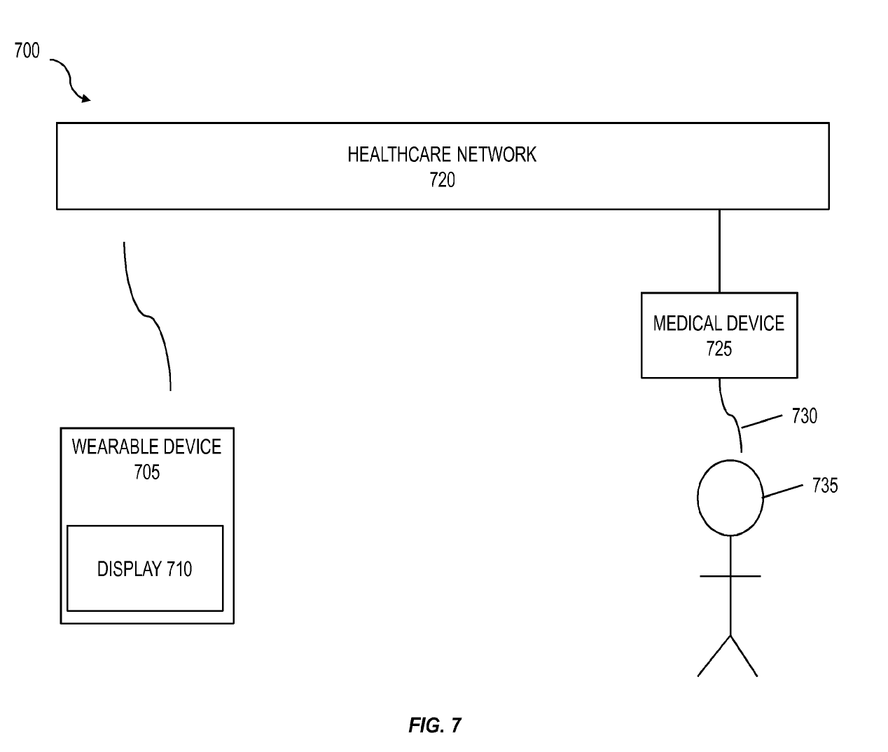

FIG. 7 is a system block diagram of an example implementation of a system 700 for monitoring a patient and displaying patient physiological parameter values in a manner that can enhance visualization of the physiological parameter data. A wearable device 705 including a display 710 is wirelessly connected to a healthcare network 720. The wearable device may include a hands-free input/output interface to provide for verbal, gestural, or touch input and output. Also connected to the healthcare network 720 is a medical device 725 having one or more sensors 730 measuring physiological parameters of a patient 735. The medical device 725 produces a feed of physiological parameter data that characterizes physical states and/or conditions of the patient. In some implementations, the medical device 725 can include a therapy device, such as an anesthesiology device or ventilator, although any device can be made to communicate as the medical device 725 and the display can be configured to meet needs accordingly.

Wearable device 705 can receive the data-feed from the medical device 725 and over healthcare network 720. The wearable device 705 can establish a low latency link such that the wearable device 705 can receive and display information in near real time. Based on the physiological parameter values in the data feed, the wearable device 705 can display graphical objects in display 710. Each graphical object can be associated with a physiological parameter and can be displayed having a size corresponding to the associated patient physiological parameter value. The graphical objects may be displayed in a substantially circular arrangement and/or may be arranged around a status object, which can be displayed and can characterize a state of at least one of the physiological parameters. In some implementations, wearable device 705 can display an interface according to FIGS. 2-6.

In some implementations, by changing relative sizes of symmetrical graphical objects visualization of changes in patient conditions can be better conveyed to a health care provider because human perception has been shown to be sensitive to changes in object symmetry. In some implementations, a clinician's response to changes in physiological parameters can be much improved by representing and displaying physiological parameter data from patients in a form having an inherent and easily discernable symmetry, with a change in the symmetry indicative of a progression or recovery from abnormal conditions. This is because studies of human interaction with computers have shown that human visual perception is very sensitive to noticing small deformations from a regular shape, such as a circle. An experienced clinician will readily notice small changes in the circle, before the patient's condition goes from normal to abnormal.

Although a few variations have been described in detail above, other modifications are possible. For example, visualization of physiological parameter data can be performed remote from a medical device and/or sensor producing the physiological parameter data or can be included on the medical device and/or sensor. Physiological parameter data can be displayed at a central monitoring and command center.

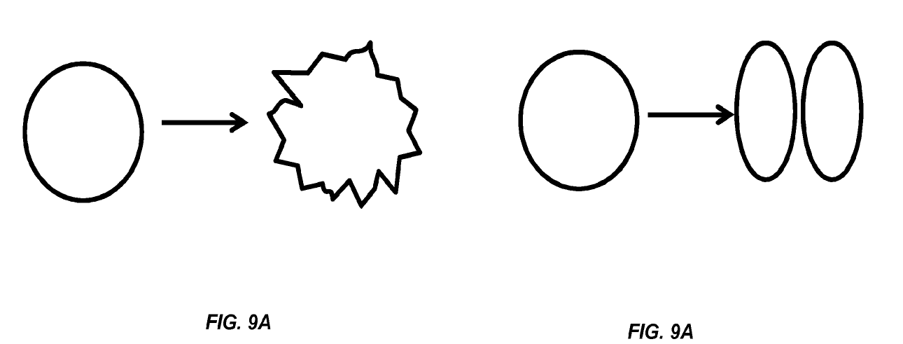

In some implementations, there may be other or additional indicators. For example, objects may dither, blink, swell, and/or move in a manner that is indicative of the magnitude or severity of change in the parameter value. In some implementations, the objects may become irregular, as illustrated in FIG. 9A. In some implementations, the objects may split, an example of which is illustrated in FIG. 9B, in which two or more sub-objects can be used to display conditions of organs or body components with a right and left characteristic (e.g., lungs, hands, and the like).

Various implementations of the subject matter described herein may be realized in digital electronic circuitry, integrated circuitry, specially designed ASICs (application specific integrated circuits), computer hardware, firmware, software, and/or combinations thereof These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server arc generally remote from each other and typically interact through a communication network. The relationship of client and server arises by virtue of computer programs running on the respective computers and having a client-server relationship to each other.

Although a few variations have been described in detail above, other modifications are possible. For example, the implementations described above can be directed to various combinations and subcombinations of the disclosed features and/or combinations and subcombinations of several further features disclosed above. In addition, the logic flows depicted in the accompanying figures and described herein do not require the particular order shown, or sequential order, to achieve desirable results. Other embodiments may be within the scope of the following claims.

1. A method for implementation by at least one hardware data processor forming part of at least one computing device, the method comprising:
receiving, by at least one data processor, a data-feed comprising patient physiological parameter values;
displaying, by at least one data processor, a plurality of graphical objects in a substantially circular arrangement, at least one of the plurality of graphical objects associated with a patient physiological parameter and having a size corresponding to a present patient physiological parameter value; and
adjusting dynamically, by at least one data processor, the size for the at least one of the plurality of graphical objects in response to changes in values of the corresponding patient physiological parameter values.

2. The method of claim 1, wherein the data-feed is received from at least one patient medical device and the at least one data processor is remote from the at least one patient medical device.

3. The method of claim 1, wherein the patient physiological parameter values of the data-feed are dynamically changing based on one or more physical conditions of a patient.

4. The method of claim 1, further comprising:
displaying, by at least one data processor and in a graphical user interface, an alarm object when an alarm condition is present in the data-feed.

5. The method of claim 1, further comprising:
displaying, by at least one data processor and in a graphical user interface, a status of a medical device generating the data-feed.

6. The method of claim 1, wherein the plurality of graphical objects are displayed in a graphical user interface residing on a display space of a wearable computing device, the display space for augmenting reality of a wearer of the wearable computing device.

7. The method of claim 1 wherein the patient physiological parameter values reflect a present value of a physiological state of a patient.

8. The method of claim 1, further comprising:
receiving an input characterizing a selection of one of the plurality of graphical objects; and
displaying a detailed graphical object comprising historical patient physiological parameter values.

9. The method of claim 1, wherein the at least one of the plurality of graphical objects is oval and the size is a length of a first symmetrical axis of the oval.

10. The method of claim 1, wherein the size is relative to a known normal value.

11. A method for implementation by at least one data hardware processor forming part of at least one computing device, the method comprising:
receiving, by at least one data processor, a data-feed comprising patient physiological parameter values;
displaying, by at least one data processor, a plurality of graphical objects arranged around a status object, at least one of the plurality of graphical objects associated with a patient physiological parameter and having a size corresponding to a present patient physiological parameter value; and
adjusting dynamically, by at least one data processor, the size for the at least one of the plurality of graphical objects in response to changes in values of the corresponding patient physiological parameter values.

12. The method of claim 11, wherein the status object displays a characterization of at least one of the patient physiological parameter values.

13. The method of claim 12, the status object characterizing at least one of the patient physiological parameter values with a warning when the patient physiological parameter values satisfy a warning condition.

14. The method of claim 11, wherein the status object displays a status of a medical device.

15. (canceled)

16. A system comprising:
at least one hardware data processor; and
memory storing instructions which, when executed by the at least one hardware data processors, implement operations comprising:
receiving, by the at least one hardware data processor, a data-feed comprising patient physiological parameter values;
displaying, by the at least one hardware data processor, a plurality of graphical objects in a substantially circular arrangement, at least one of the plurality of graphical objects associated with a patient physiological parameter and having a size corresponding to a present patient physiological parameter value; and
adjusting dynamically, by the at least one hardware data processor, the size for the at least one of the plurality of graphical objects in response to changes in values of the corresponding patient physiological parameter values.

17. The system of claim 16, wherein the data-feed is received from at least one patient medical device and the at least one data processor is remote from the at least one patient medical device.

18. The system of claim 17, wherein the patient physiological parameter values of the data-feed are dynamically changing based on one or more physical conditions of a patient.

19. The system of claim 16, wherein the plurality of graphical objects are displayed in a graphical user interface residing on a display space of a wearable computing device, the display space for augmenting reality of a wearer of the wearable computing device.

20. The method of claim 16, wherein the patient physiological parameter values reflect a present value of a physiological state of a patient.

21. The system of claim 16, wherein the at least one of the plurality of graphical objects is oval and the size is a length of a first symmetrical axis of the oval and is relative to a known normal value.
